(19) United States
(12) Patent Application Publication
(10) Pub. No.: US 2005/0098989 A1
(43) Pub. Date: May 12, 2005

(54) Device for controlling multi-stage or dual igniter airbags in motor vehicles

(76) Inventor: Robert Netherton Brown JR., Frederick, MD (US)

Correspondence Address: Robert Netherton Brown, Jr., 7301 Brookside Drive, Frederick, MD, 21702, US

(21) Appl. No.: 10/780,812

(22) Filed: Feb. 18, 2004

Related U.S. Application Data
(63) Continuation-in-part of application No. 10/703,050, filed on Nov. 6, 2003.

(51) Int. Cl. B60R 21/32

(52) U.S. Cl. 280/735

(57) ABSTRACT

A device for controlling a multi-stage or dual igniter airbag in motor vehicles having a common bypass circuit which only contains one resistor for use by multiple circuits within an airbag switch simultaneously. The preferred embodiment includes use of one or more additional circuits to filter out induced electromagnetic waves, such as radio waves, thereby reducing the possibility of unintentional airbag detonation.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of passenger motor vehicles and more specifically to a device for controlling multi-stage or dual igniter airbags in motor vehicles.

Originally airbags were developed with a single detonation circuit, but the force required for an airbag to stop an occupant in the event of an accident was excessive, and resulted in many injuries and deaths; most from low speed accidents. Since 2000, airbag systems have come into use that include a multi-stage airbag to help reduce the force of airbag detonation in low speed accidents, with the intention of making airbag detonation safer for a vehicle's occupants.

Originally, a single stage airbag switch patent was awarded, and was intended to control a single stage airbag; turning it on or off depending on the preferences of the vehicle's occupant. Dual igniter airbags were introduced by some manufacturers in which there were two detonators. Patents were awarded for an airbag switch that simply put two of these single airbag switch circuits into one airbag switch box so that it could be used to manually control an airbag with two detonators such as a dual igniter airbag or a multistage airbag.

These airbag switches were developed to satisfy the minimum requirements mandated in the Federal Motor Vehicle Safety Standard (FMVSS No. 208, Occupant Crash Protection).

Multi-stage airbag switches also used separate resistors and fuses for each bypass circuit, increasing cost and potential incidence of errors in manufacture, and also rendering the airbag switch useless to perform its required function once it had passed a detonation charge in the “Airbag Off” position, and a fuse had opened in the bypass circuit. This made it necessary to replace the entire airbag switch once a detonation impulse passed through the bypass circuits.

This invention includes only one resistor common to all bypass circuits, and no fuses. In addition, one embodiment includes additional filter circuits to minimize the possibility of accidental detonation of the airbag from inductive reactance, including from radio waves.

### BRIEF SUMMARY OF THE INVENTION

The primary object of the invention is To provide a multi-stage airbag switch, that requires fewer parts in order to perform its basic functions.

Another object of the invention is to provide a novel electronic circuit in conjunction with the airbag switch to filter out electromagn tic waves from other sources, such as from radio waves, and therefore to reduce the possibility of accidental detonation of the airbag from inductive reactance.

A further object of the invention is to provide an airbag switch with longer life and that does not have to be replaced each time a detonation current passes through the bypass circuit.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a device for controlling a multi-stage or dual igniter airbag in motor vehicles comprising: A bypass circuit which only contains one common resistor for simultaneous use by multiple circuits within an airbag switch, as well as circuitry to filter out possible unintentional currents from inductive reactance.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the airbag switch box.

FIG. 2 is an electrical schematic of the circuit embodied in the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

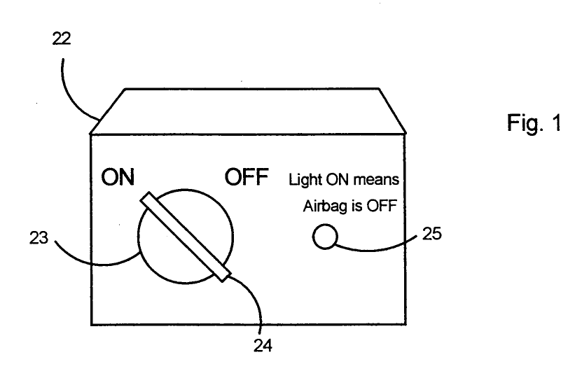

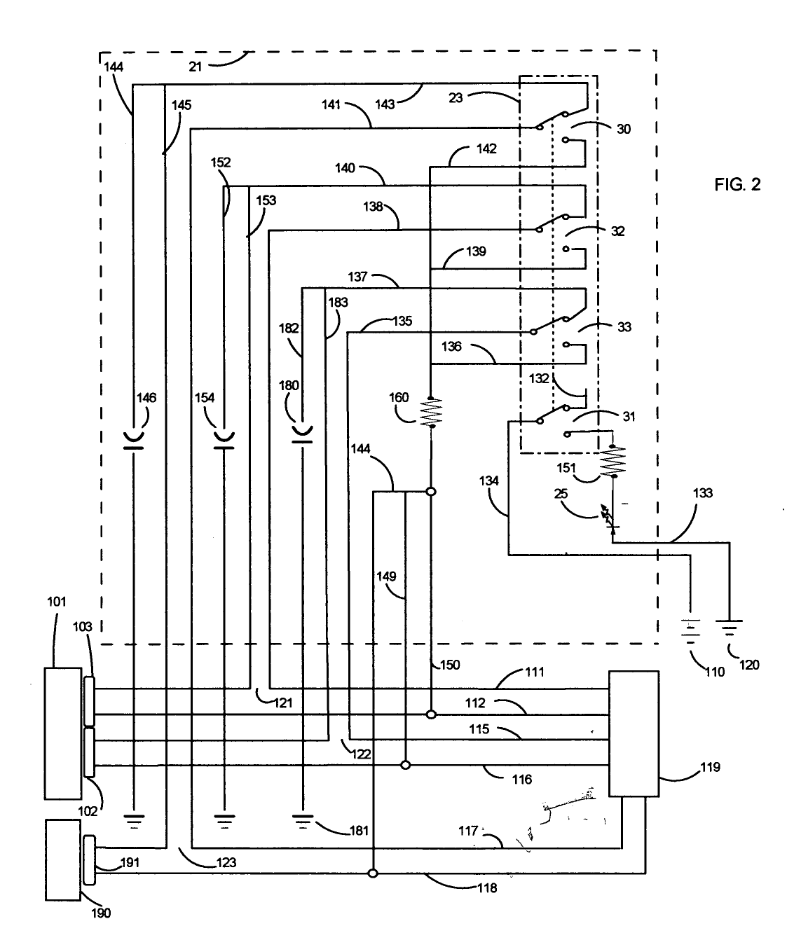

Turning first to FIG. 1 there is shown a device 21 (see FIG. 2) for controlling the deployment of a multistage airbag in a motor vehicle. The device has a rectangular housing 22 with a two position (“on and off”) key-operated switch 23 on the front face. A manual engagement actuaor, such as a removable key 24 is provided for actuating the switch mechanism 23. The device includes an optical device such as one light emitting diode (LED) 25, for visual confirmation of the switch position selected. When the airbag is turned off, the LED 25 is illuminated as long as the vehicle's ignition is turned on. When the airbag is active there is no light. The exterior case of the switch includes lettering to indicate whether the airbag is active or disconnected.

Turning to FIG. 2, an electrical diagram for connecting switch device 21 to a multi-stage airbag module 101 having two igniters 102, 103 is shown. Typically, a sensor in the vehicle will determine the severity of the impact of the vehicle during an accident. If the impact is less severe, only one of the igniters 102 or 103 ignites to inflate airbag 101. If the impact is more severe, both igniters 102, 103 ignite to inflate the airbag 101. Each igniter is connected through a pair of wires 111, 112 and 115, 116 respectively to the vehicle's airbag controller 119, which monitors and controls the operation of the vehicle's Supplemental Restraint System, among other functions, including the airbag module 101 and its igniters 102,103. Without device 21, the airbag controller would be connected directly to the multi-stage airbag through wires 111,112 and 115, 116. However, with device 21, wires 111 and 115 are interrupted at breaks 121 and 122, respectively and connected to device 21.

In the embodiment shown in FIG. 2, switch 23 is a four-pole, double-throw switch. Switch 23 has a first pole 31 connected with wire 133 to the LED 25 and its resistor 151 and then to the vehicle's ground 120. This circuit is completed when pole 31 connects wire 133 to an external power source 110 through wire 134.

The preferred embodiment is shown which comprises multiple circuits simultaneously switched by the keyed four pole switch 23 for controlling multiple igniter airbags in motor vehicles. The device comprises multiple bypass circuits 136, 139, 142 to simulate each of the airbag's igniters when the airbag 101 is switched OFF, and all bypass circuits share one, common resistor 160. The device also contains a separate circuit to indicate the status of the airbag by illuminating the LED 25 when the airbag is turned off, as long as the vehicle's ignition is On.

One feature of the invention is the inclusion of a fourth circuit 141, 142 and 143 within the device 21, also simultaneously controlled by the fourth pole 30 of the switch mechanism 23. This fourth circuit can be used to control the third stage detonator of a three stage airbag (not shown) or a separate one-stage airbag 190 with igniter 191 in the vehicle such as a side airbag.

In operation, device 21 may be turned off to prevent the airbag module 101 from deploying in the event of a collision, or turned on to allow module 101 to deploy. When device 21 is “On” (FIG. 2), poles 30, 31, 32, and 33 are simultaneously thrown or actuated to the upper position. This allows the circuits to be completed between the vehicle's airbag controller, 119 and the airbag 101 through wires 138, 140 and 135, 137. At the same time, pole 31 connects to the terminal for wire 132, so that the L.E.D. 25 is not illuminated. In the fourth circuit, wire 141 is connected to wire 143 by pole 30 to activate a third airbag detonator 191.

When device 21 is “Off” (not shown), poles 30, 31, 32, and 33 are simultaneously thrown to the lower position. This interrupts the circuit between the vehicle's airbag controller 119 and the airbag 101 at breaks 121 and 122. This connects wires 135, 138 and 141 to the bypass circuit wires 136,139 and 142 respectively, which pass through the common bypass resistor 160 and back into the airbag detonation circuit. In effect, this shunts bypass resistor 160 between wires 111 and 112, and between wires 115 and 116. With the airbag switch in the OFF position, the fourth pole 30 interrupts the circuit through wire 117 from the airbag controller 119 to the single stage airbag detonator 191, or third stage of a three stage airbag (not shown) at break 123 and completes the circuit from wire 141 to wire 142, then through the common resistor 160 to wire 118. Pole 31 simultaneously activates the LED 25 to emit a yellow light to indicate that the airbag is turned “Off” and will not deploy.

The preferred embodiment includes wires 182, 152 and 144 which connect wires 143, 140 and 137 to capacitors 146, 154 and 180 respectively while the airbag switch 23 is in the ON position, and then to ground 181 which will filter out current induced by inductive reactance, which could cause unintentional airbag detonation. At the same time, wires 135, 138 and 141 are connected to wires 183, 153, and 145 completing electrical conductivity between the airbag detonators 102, 103 and the airbag controller 119 and between detonator 191 and the airbag controller 119.

While the invention has been described in only one of its forms, it should be apparent to those skilled in the art that it is not so limited, but is susceptible to various changes without departing from the scope of the invention. The device shown and described could be configured for more airbag modules by adding more poles and bypass circuits connected to use the one bypass resistor 160.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. In a motor vehicle airbag system, having a module (101) with a plurality of igniters (102,103) for causing an airbag to inflate, a diagnostic monitor (119) that determines if a collision is occurring and initiates the igniters, and first and second pairs of wires (111,112) and (115, 116) extending between the module (101) and the monitor (119), the improvement comprising:
a manually operable switch (23) having portions thereof connected to each of the first wires (111,115) of each said pair of wires for selectively providing continuity through the first wires between the monitor (119) and each of the igniters (102,103) while in an ON position and for selectively breaking continuity through the first wires between the monitor (119) and each of the igniters (102,103) while in an OFF position;
a single common resistor (160) connected to the second wire (112,116) of each said pair of wires (111,112) and (115,116) and connected to the switch (23), so that while in the OFF position, the switch places said single, common resistor (160) in series circuit relatively between the first and second wires in each said pair of wires (111,112) and 115,116); and
wherein the common resistor (160) has an impedance similar to that of each igniter(102,103), so as to provide a false indication to the monitor (119) that electrically conductive continuity exists with each igniter (102,103) while the switch (23) is in the OFF position.

2. The airbag system according to claim 1, further comprising filter circuits 182, 152 and 144 so that inductively induced electromagnetic waves are removed when the airbag switch is in the ON position, by passing these waves through capacitors 180, 154 and 146, respectively to ground (181), rather than allowing unintentional alternating current electrical impulses to reach the airbag detonators (102,103) and 191 and cause an unintended detonation.

3. The airbag system according to claim 1, further comprising an optical signal device (25) connected to the switch (23) to provide an optical signal while the switch (23) is in the OFF position.

4. The airbag system according to claim 1 wherein the switch (23) includes poles (32,33) connected to each of the first wires (111,115), the poles (32,33) being movable in unison when the switch (23) moves between the ON and OFF positions.

5. The airbag system according to claim 1, further comprising:
a housing (22) adapted to be mounted within the motor vehicle, the switch (23) and the resistor (160) being located within the housing (22), the switch (23) having a manual engagement portion located on an exterior of the housing (22) for engagement by a user.

6. The airbag system according to claim 1, further comprising:
a housing (22) adapted to be mounted within a motor vehicle, the switch (23) and the resistor (160) being located within the housing (22), the switch (23) having a manual engagement portion located on an exterior of the housing (22) for engagement by a user, and
an optical device (25) connected to the switch (23) for providing an optical signal while the switch (23) is in the OFF position, the optical signal device being mounted to the exterior of the housing (22).

7. In a motor vehicle airbag system, having a module (101) with a plurality of igniters (102,103) for causing an airbag to inflate, a diagnostic monitor (119) that determines if a collision is occurring and initiates the igniters, and first and second sets of wires (111,112) and (115,116) extending between each of the igniters and the monitor for conveying signals between the module (101) and the monitor (110), the improvement comprising:
a break (121,122) in the first wire (111,115) of each set of wires (111,112) and (115, 116) respectively, interrupting electrically conductive continuity between the monitor (119) and each of the igniters (102) and (103) respectively;
a housing (22) adapted to be mounted in a passenger compartment of the motor vehicle;
a first pair of leads (135,138) from the airbag switch (23) connected to each of the first wires (111,115) respectively, and a second pair of leads (137,140) from the airbag switch (23) connecting to the airbag igniters (102,103) each set of said first and second pairs of leads extending into the housing (23); one, common resistor (160) mounted in the housing (22); a manually operable switch (23) mounted in the housing (22) and having
a manual engagement actuator (24) on an exterior of the housing (22), the switch (23) having a pole (32,33) for each igniter (102,103) respectively, each of the pol s (32,33) being connected to one of the first wires (111,115) respectively, of each of the sets of wires (111,112) and (115,116), each of the poles having an ON position that connects the first wires (111,115) in electrically conducting relationship between said monitor (119) and said ignitors (102,103) respectively, each of the poles (32,33) having an OFF position that breaks said electrically conducting relationship and connects said first wires (111,115) with the one comon resistor(160), the one common resistor (160) being electrically connected to the second wire (112,116) in each wire set so that while in an OFF position, the poles (32,33) place the resistor (160) in series between the first and second wires (111,112) and (115,116) of each set of wires, the resistor (160) having an impedance similar to that of each of the igniters (102,103) so as to avoid a fault signal by the monitor (119) while the switch (23) is in the OFF position.

8. The airbag system according to claim 7, wherein the switch (23) has at least three poles and is a double-throw.

9. A method of controlling airbag deployment of a motor vehicle airbag system having a module (101) with a plurality of igniters (102,103) for causing an airbag to inflate, a diagnostic monitor (119) that determines if a collision is occurring and initiates the igniters, first (111,115) and second (112,116) wires extending between each of the igniters (102,103) and the monitor (119) for conveying signals between the module (101) and the monitor (119), the method comprising the steps of:
severing each of the first wires (111,115) between the igniters (102,103) and the monitor (119), creating a pair of ends (138,135) for each of the first wires (111,115);
connecting a portion of a manually operable switch (23) to the ends (135,138) of each of the first wires (111,115);
connecting one side of a resistor (160) to each of the second wires (112,116) and the other side to the switch (23), the one resistor (160) having an impedance similar to each of the igniters (102,103);
placing the switch in an ON position, providing electrically conductive continuity in the first wires (111,115) between the monitor (119) and each of the igniters (102,103); then placing the switch in an off position, breaking continuity in the first wires (111,115) between the monitor (119) and each of the igniters (102,103) and simultaneously placing the common resistor (160) in series between the first and second wires (111,112) and (115,116) and the monitor (119), the resistor (160) having an impedance similar to each of the igniters (102,103) so as to provide a false indication to the monitor (119) that electrically conductive continuity exists between the igniters (102,103) and the monitor (119) while the switch is in the OFF position.

10. The method as recited in claim 8, further comprising the steps of:
providing an illuminated signal while the switch (23) is in the OFF position.

11. The airbag system according to claim 1, further comprising:
Filter circuits (152,182,145) connected to each of said first wires (111,115,117) to reduce the possibility of unintentional detonation from inductive reactance created by electromagnetic waves, such as radio frequency waves or similar sources.
